(19) United States
(12) Patent Application Publication
(10) Pub. No.: US 2023/0369819 A1
(43) Pub. Date: Nov. 16, 2023

(54) Insertion Device and Method of Inserting Cable Assembly Into Housing

(71) Applicants: Tyco Electronics (Shanghai) Co., Ltd., Shanghai (CN); TE Connectivity Solutions GmbH, Schaffhausen (CH)

(72) Inventors: An (Joshua) Yang, Shanghai (CN); Lvhai (Samuel) Hu, Shanghai (CN); Roberto Francisco-Yi Lu, Bellevue, WA (US)

(73) Assignees: Tyco Electronics (Shanghai) Co., Ltd., Shanghai (CN); TE Connectivity Solutions GmbH, Schaffhausen (CH)

(21) Appl. No.: 18/316,372

(22) Filed: May 12, 2023

(30) Foreign Application Priority Data
May 13, 2022 (CN) 202210523265.4

(51) Int. Cl. H01R 43/052

(52) U.S. Cl. CPC H01R 43/052; H01R 4/4818

(57) ABSTRACT

An insertion device for inserting a cable assembly into a housing comprises a cable control module and a housing control module. The cable control module includes a terminal clamping device adapted to clamp to two terminals of the cable assembly, and a core wire clamping device adapted to clamp to two core wires of the cable assembly on which the terminals are crimped. The housing control module includes a housing clamping device adapted to hold the housing while the two terminals are inserted into the housing.

### CROSS-REFERENCE TO RELATED APPLICATIONS

This application claims the benefit of Chinese Patent Application No. CN202210523265.4 filed on May 13, 2022, in the State Intellectual Property Office of China, the whole disclosure of which is incorporated herein by reference.

### FIELD OF THE INVENTION

The present invention relates to an insertion device and a method for inserting a cable assembly into a housing with the insertion device.

### BACKGROUND

In the prior art, an electrical connection terminal of a dual-core cable assembly is usually inserted into a connector housing manually. However, the manual insertion process is inefficient and easily results in terminal or core wire damage.

### SUMMARY

According to an embodiment of the present disclosure, an insertion device for inserting a cable assembly into a housing comprises a cable control module and a housing control module. The cable control module includes a terminal clamping device adapted to clamp to two terminals of the cable assembly, and a core wire clamping device adapted to clamp to two core wires of the cable assembly onto which the two terminals are crimped. The housing control module includes a housing clamping device adapted to hold the housing while the two terminals are inserted into the housing.

### BRIEF DESCRIPTION OF THE DRAWINGS

The invention will now be described by way of example with reference to the accompanying Figures, of which:

FIG. 1 is an illustrative perspective view of a connector according to an exemplary embodiment of the present invention;

FIG. 2 is an illustrative perspective view of a cable assembly and a housing of a connector according to an exemplary embodiment of the present invention;

FIG. 3 is an illustrative perspective view of an insertion device according to an exemplary embodiment of the present invention;

FIG. 4 is an illustrative perspective view of a housing control module of an insertion device according to an exemplary embodiment of the present invention;

FIG. 5 is an illustrative perspective view of a housing clamping device of a housing control module of an insertion device according to an exemplary embodiment of the present invention;

FIG. 6 is an illustrative perspective view of a guiding device of a housing control module of an insertion device according to an exemplary embodiment of the present invention;

FIG. 7 is an illustrative perspective view of a cable control module of an insertion device according to an exemplary embodiment of the present invention;

FIG. 8 is a partially enlarged schematic diagram of a cable control module of an insertion device according to an exemplary embodiment of the present invention;

FIG. 9 is an illustrative perspective view of a terminal clamping device of a cable control module of an insertion device according to an exemplary embodiment of the present invention;

FIG. 10 is an illustrative perspective view of a terminal clamp of a terminal clamping device of a cable control module of an insertion device according to an exemplary embodiment of the present invention;

FIG. 11 is an illustrative perspective view of a core wire clamping device of a cable control module of an insertion device according to an exemplary embodiment of the present invention; and

FIG. 12 is an illustrative perspective view of a core wire clamp of a core wire clamping device of a cable control module of an insertion device according to an exemplary embodiment of the present invention.

### DETAILED DESCRIPTION OF THE EMBODIMENTS

Exemplary embodiments of the present disclosure will be described hereinafter in detail with reference to the attached drawings, wherein the like reference numerals refer to the like elements. The present disclosure may, however, be embodied in many different forms and should not be construed as being limited to the embodiment set forth herein; rather, these embodiments are provided so that the present disclosure will be thorough and complete, and will fully convey the concept of the disclosure to those skilled in the art.

In the following detailed description, for purposes of explanation, numerous specific details are set forth in order to provide a thorough understanding of the disclosed embodiments. It will be apparent, however, that one or more embodiments may be practiced without these specific details. In other instances, well-known structures and devices are schematically shown in order to simplify the drawing.

According to an embodiment of the present disclosure, an insertion device for inserting a cable assembly into a housing is provided. The cable assembly comprises a cable and two terminals crimped on two exposed core wires of the cable. The insertion device comprises a cable control module and a housing control module. The cable control module includes a terminal clamping device for clamping two terminals, and a core wire clamping device for clamping two core wires. The housing control module comprises a housing clamping device for holding the housing when two terminals are inserted into the housing. During the process of inserting the parts of the two terminals other than their roots into the housing, the terminal clamping device is clamped on the roots of the two terminals and the core wire clamping device is in an open state of not clamping the two core wires. During the process of inserting the roots of the two terminals into the housing, the terminal clamping device is in an open state and not clamping the two terminals, and the core wire clamping device is clamped on the roots of the two core wires.

According to another embodiment of the present disclosure, a method for inserting a cable assembly into a housing is provided. The cable assembly comprises a cable and two terminals crimped on two exposed core wires of the cable. The method comprises steps of: 1) providing the above insertion device; 2) clamping the housing with the housing clamping device, and clamping the roots of the two terminals with the terminal clamping device; 3) by moving the mobile seat, the front ends of the two terminals are inserted into the housing under the guidance of the guide device; 4) after the front ends of the two terminals are inserted into the housing, stopping the mobile seat and opening the guide device; 5) further inserting the two terminals by moving the mobile seat until the parts of the two terminals other than their roots are inserted into the housing; 6) after the parts of the two terminals other than their roots are inserted into the housing, stopping the mobile seat, opening the terminal clamping device and clamping the roots of the two core wires with the core wire clamping device; 7) further inserting the two terminals by moving the mobile seat until the roots of the two terminals are inserted into the housing; 8) after the roots of the two terminals are inserted into the housing, stopping the mobile seat and opening the core wire clamping device; and 9) further inserting the two terminals by moving the mobile seat until the roots of the two core wires are inserted into the housing.

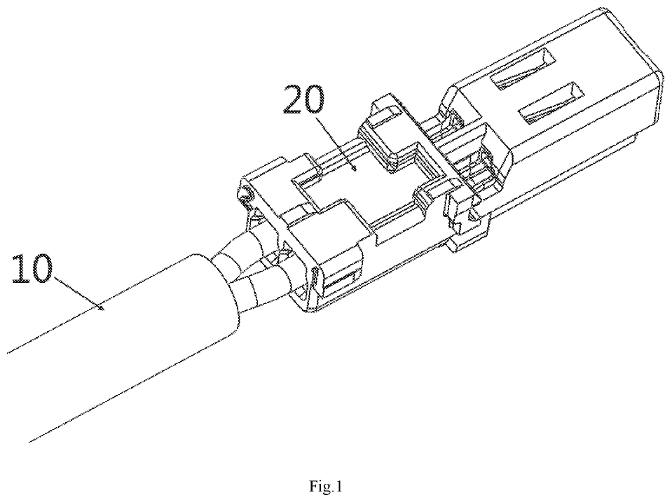

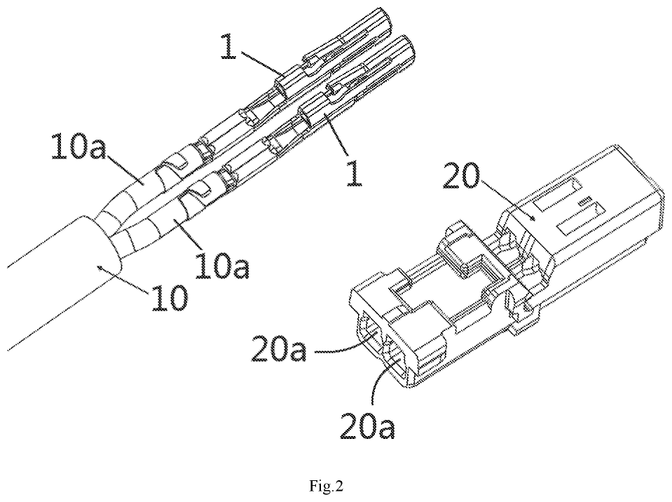

FIG. 1 is an illustrative perspective view of a connector according to an exemplary embodiment of the present invention. FIG. 2 is an illustrative perspective view of the cable assembly and housing of the connector according to an exemplary embodiment of the present invention. As shown in FIGS. 1 and 2, the connector includes a cable assembly 10,1 and a housing 20. The cable assembly 10,1 includes a cable 10 and two terminals 1 crimped on two exposed core wires 10a of the cable 10 respectively. When assembling the connector, the two terminals 1 of cable assembly 10,1 are inserted into the housing 20.

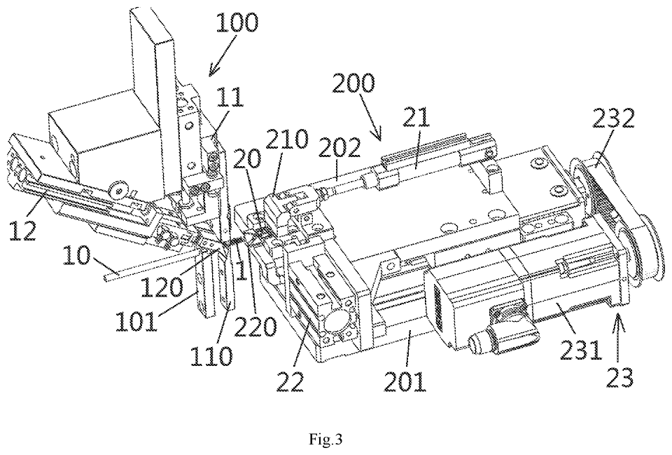

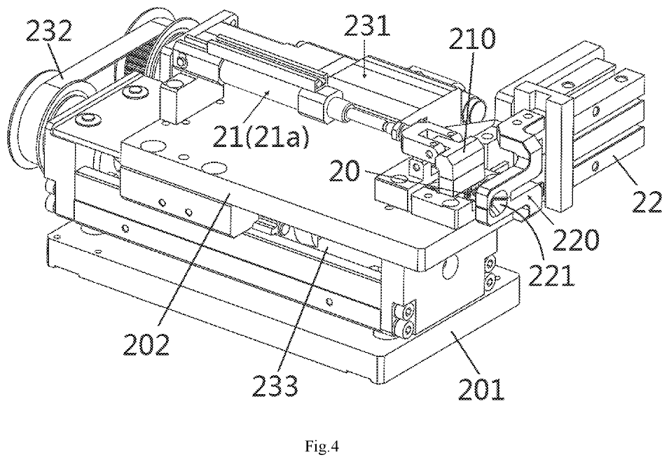

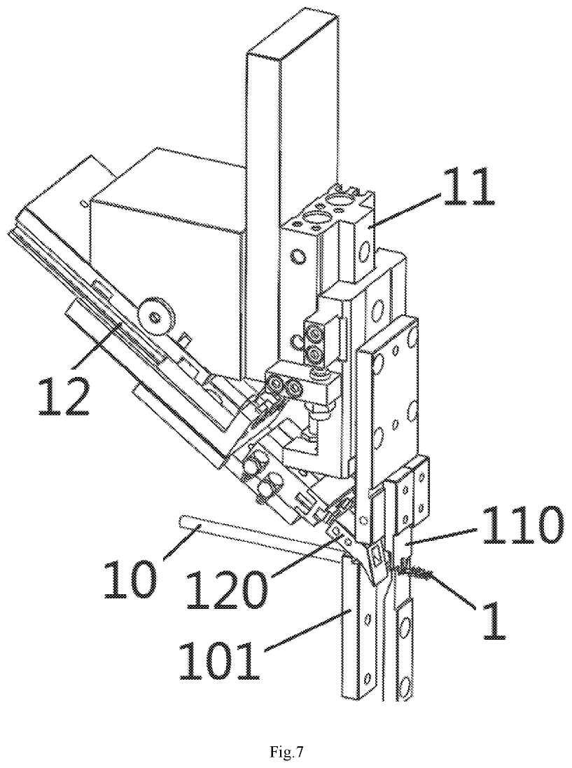

FIG. 3 is an illustrative perspective view of an insertion device according to an exemplary embodiment of the present invention. FIG. 4 is an illustrative perspective view of the housing control module 200 of the insertion device according to an exemplary embodiment of the present invention. FIG. 7 is an illustrative perspective view of the cable control module 100 of the insertion device according to an exemplary embodiment of the present invention. As shown in FIGS. 1-4 and 7, the insertion device is used to insert the cable assembly 10,1 into the housing 20. The insertion device mainly includes a cable control module 100 and a housing control module 200. The cable control module 100 mainly includes a terminal clamping device 110,11 and a core wire clamping device 120,12. The terminal clamping device 110,11 is used to clamp two terminals 1. The core wire clamping device 120,12 is used to clamp two core wires 10a. The housing control module 200 mainly includes a housing clamping device 210,21, which is used to hold the housing 20 during the insertion of two terminals 1 into the housing 20.

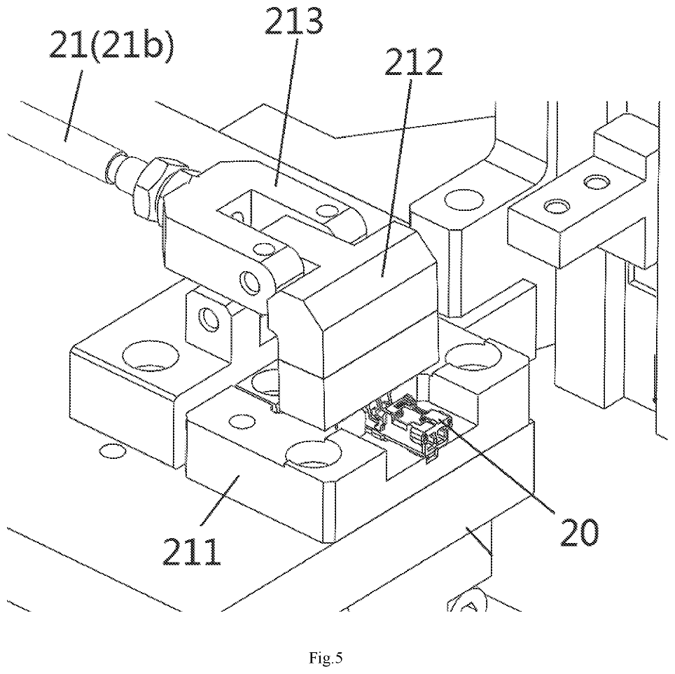

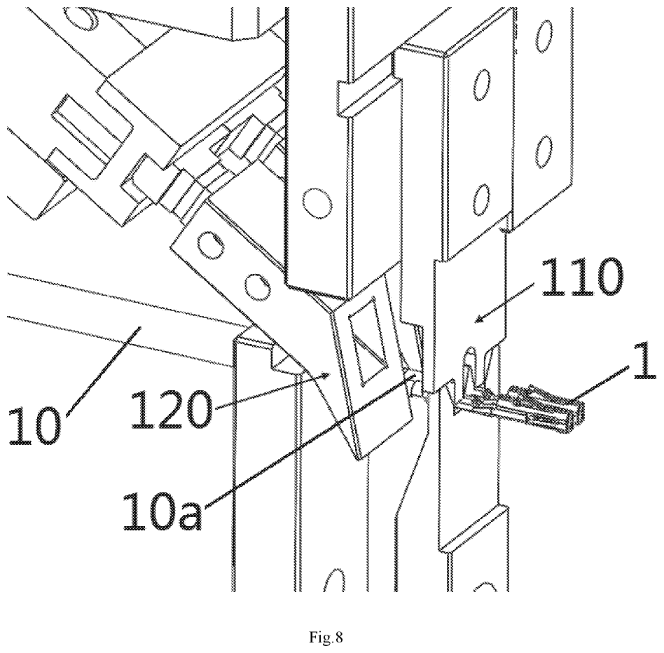

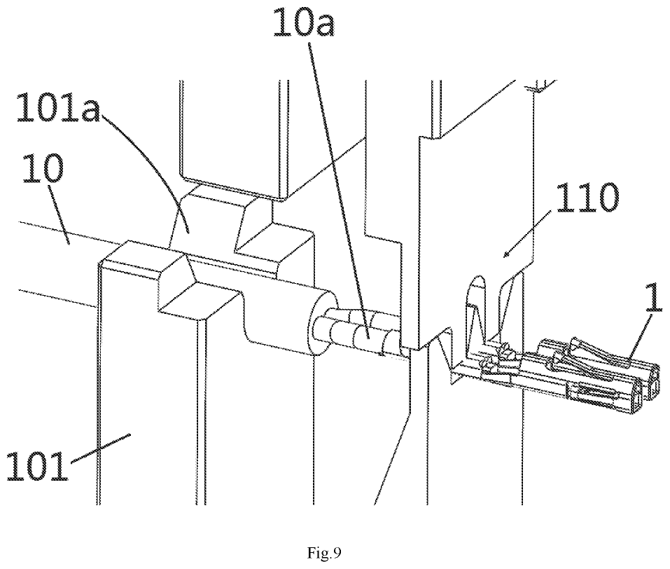

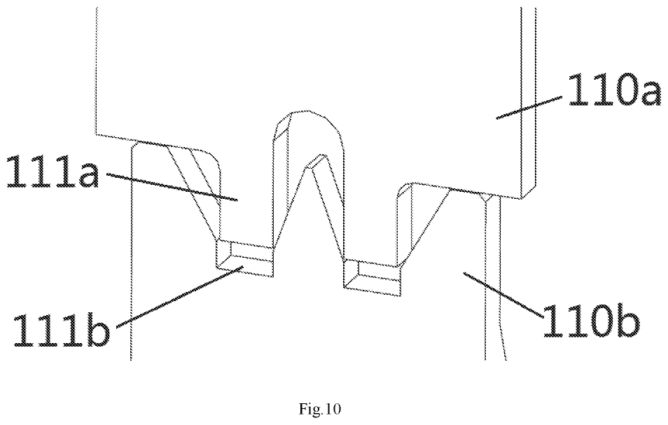

FIG. 5 is an illustrative perspective view of the housing clamping device 210,21 of the housing control module 200 of the insertion device according to an exemplary embodiment of the present invention. FIG. 8 is a partially enlarged schematic diagram of the cable control module 100 of the insertion device according to an exemplary embodiment of the present invention. FIG. 9 is an illustrative perspective view of terminal clamping device 110,11 of the cable control module 100 of the insertion device according to an exemplary embodiment of the present invention. FIG. 10 is an illustrative perspective view of terminal clamp 110 of terminal clamping device 110,11 of the cable control module 100 of the insertion device according to an exemplary embodiment of the present invention.

As shown in FIGS. 1-5 and FIGS. 7-10, during the process of inserting the parts of the two terminals 1 other than their roots into the housing 20, the terminal clamping device 110, 11 is clamped on the roots of the two terminals 1, and the core wire clamping device 120, 12 is in the open state of not clamping the two core wires 10a. As shown in FIG. 1-5 and FIG. 7-10, in the illustrated embodiment, during the process of inserting the roots of the two terminals 1 into the housing 20, the terminal clamping device 110,11 is in the open state of not clamping the two terminals 1, and the core wire clamping device 120,12 is clamped on the roots of the two core wires 10a.

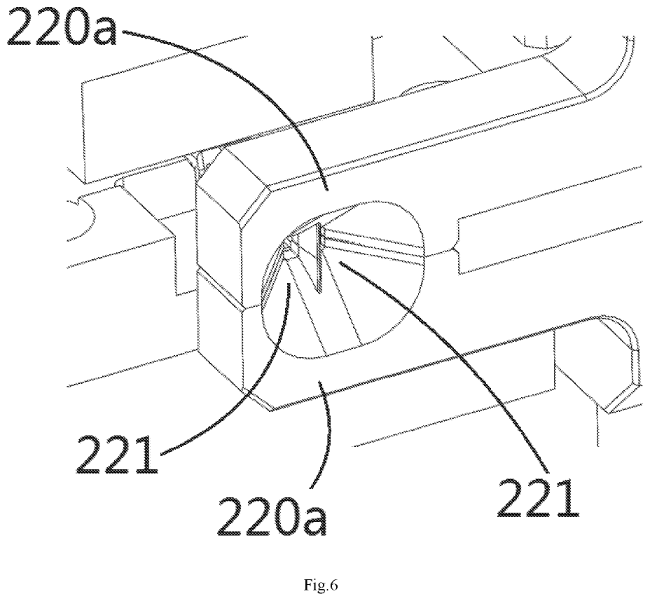

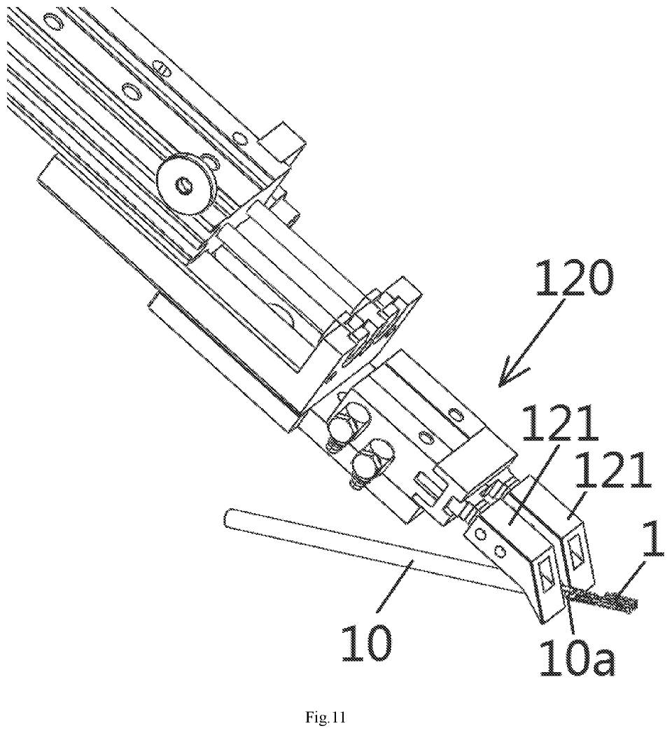

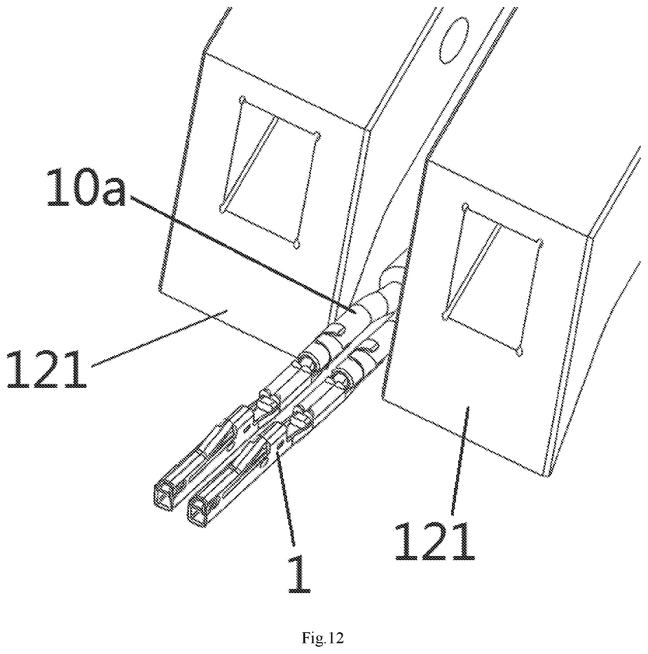

FIG. 6 is an illustrative perspective view of the guiding device 220,22 of the housing control module 200 of the insertion device according to an exemplary embodiment of the present invention. FIG. 11 is the illustrative perspective view of the core wire clamping devices 120,12 of the cable control module 100 of the insertion device according to an exemplary embodiment of the present invention. FIG. 12 is an illustrative perspective view of the core wire clamping device 120 and the core wire clamp 120 of the core wire clamping device 120 of the cable control module 100 of the insertion device according to an exemplary embodiment of the present invention. As shown in FIGS. 1-12, the housing control module 200 also includes a mobile seat 202. The mobile seat 202 can move relative to the terminal 1 along the longitudinal direction of the terminal 1. The housing clamping device 210,21 is installed on the mobile seat 202, so that the two terminals 1 can be inserted into the housing 20 by driving the mobile seat 202.

The housing clamping device 210, 21 includes a housing clamp 210 and a housing clamp driver 21. The housing clamp 210 is installed on the mobile seat 202 and can be opened and closed to clamp or loosen the housing 20. The housing clamp driver 21 is installed on the mobile seat 202 to drive the housing clamp 210 to open and close.

The housing clamp 210 comprises a base 211, a clamping arm 212 and a connecting arm 213. The base 211 is fixed on the mobile seat 202 and has a positioning groove for positioning the housing 20. The clamping arm 212 is rotatably connected to the base 211 and can be opened and closed relative to the base 211 to clamp or loosen the housing 20. The connecting arm 213 is rotatably connected to the clamping arm 212. The housing clamp driver 21 includes a cylinder, the cylinder block 21a of the cylinder is rotatably connected to the mobile seat 202, and the telescopic rod 21b of the cylinder is connected to the connecting arm 213.

The housing control module 200 also includes a guide device 220,22, which is installed on the mobile seat 202 to guide the front ends of two terminals 1 into the housing 20. The guide device 220, 22 includes a guide member 220 and a guide member driver 22. The guide member 220 includes a pair of guide member halves 220a that can be opened and closed. The guide driver 22 is used to drive the pair of guide member halves 220a to open and close. A semi-conical guide hole is formed on the guide member half 220a. When the pair of guide member halves 220a is closed, a conical guide hole 221 is formed to guide the terminal 1 into the housing 20.

Two semi-conical guide holes arranged side by side are formed on the guide member half 220a. When the pair of guide member halves 220a is closed, two conical guide holes 221 arranged side by side are formed to guide two terminals 1 into two terminal slots 20a of the housing 20. In the process of inserting the front ends of the two terminals 1 into the housing 20, the pair of guide member halves 220a are closed to form two conical guide holes 221 for guiding the two terminals 1 into the housing 20. When the front ends of the two terminals 1 have been inserted into the housing 20, the pair of guide member halves 220a are opened to allow the parts other than the front ends of the two terminals 1 to be inserted into the housing 20.

The housing control module 200 also includes a fixed seat 201 and a mobile seat driver 23. The mobile seat 202 is movably installed on the fixed seat 201. The mobile seat driver 23 is installed on the fixed seat 201 to drive the mobile seat 202 to move along the longitudinal direction of the terminal 1. The mobile seat driver 23 includes a servo motor 231 and a transmission mechanism 232,233. The servo motor 231 is installed on the fixed seat 201. The transmission mechanism 232,233 is connected between the output shaft of the servo motor 231 and the mobile seat 202. The transmission mechanism 232,233 is used to convert the rotation of the output shaft of the servo motor 231 into the linear movement of the mobile seat 202.

The drive mechanisms 232,233 include a pulley drive mechanism 232 and a lead screw drive mechanism 233. The lead screw drive mechanism 233 includes a lead screw (not shown) and a nut (not shown) threaded with the lead screw. The nut of the lead screw drive mechanism 233 is connected to the mobile seat 202. The pulley drive mechanism 232 is connected between the output shaft of the servo motor 231 and the lead screw of the lead screw drive mechanism 233.

The terminal clamping device 110,11 includes a terminal clamp 110 and a terminal clamp driver 11. The terminal clamp 110 includes two terminal clamp halves 110a,110b that can be opened and closed. The terminal clamp driver 11 is used to drive the two terminal clamp halves 110a,110b to open and close to clamp or loosen the two terminals 1.

Two terminal positioning grooves 111b are formed on one of the two terminal fixture halves 110a and 110b for positioning the roots of the two terminals 1 respectively. Two terminal positioning protrusions 111a are formed on the other of the two terminal fixture halves 110a,110b to keep the roots of the two terminals 1 in the two terminal positioning grooves 111b respectively. The two terminals 1 are arranged side by side in a first direction, and the first direction is vertical to the longitudinal direction of terminal 1. The two terminal clamp halves 110a,110b are opened and closed in a second direction perpendicular to the first direction and the longitudinal direction of terminal 1.

The core wire clamping device 120,12 includes a core wire clamp 120 and a core wire clamp driver 12. The core wire clamp 120 includes a pair of core wire clamp halves 121 that can be opened and closed. The core wire clamp driver 12 is used to drive the pair of core wire clamp halves 121 to open and close to clamp or loosen two core wires 10a. The two terminals 1 are arranged side by side in the first direction, and the first direction is vertical to the longitudinal direction of terminal 1. The pair of core wire clamp halves 121 are opened and closed in the first direction. The two exposed core wires 10a of the cable 10 are arranged side by side in the first direction. In the process of inserting the roots of the two terminals 1 into the housing 20, the pair of core wire clamp halves 121 hold the two core wires 10a in the first direction. After the roots of the two terminals 1 are inserted into the housing 20, the core wire clamping device 120,12 is opened to allow further insertion of the two terminals 1 until the roots of the two core wires 10 enter the housing 20.

The cable control module 100 also includes a cable support frame 101, on which a cable positioning slot 101a for positioning and supporting the cable 10 is formed. The cable control module 100 also includes a frame (not shown). The terminal clamping device 110, 11, the core wire clamping device 120, 12 and the cable support frame 101 are installed on the frame.

In an exemplary embodiment of the present invention, a method for inserting the cable assembly 10,1 into the housing 20 is also disclosed. The cable assembly 10, 1 includes a cable 10 and two terminals 1 crimped on two exposed core wires 10a of the cable 10 respectively. The preceding method includes the following steps of:
S10: providing the insertion device as shown in FIGS. 3-12;
S20: clamping the housing 20 with the housing clamping device 210,21, and clamping the roots of the two terminals 1 with the terminal clamping device 110,11;
S30: by moving the mobile seat 202, the front ends of the two terminals 1 are inserted into the housing 20 under the guidance of the guide device 220;
S40: after the front ends of the two terminals 1 are inserted into the housing 20, stopping the mobile seat 202 and opening the guide device 220;
S50: further inserting the two terminals 1 by moving the mobile seat 202 until the parts of the two terminals 1 other than their roots are inserted into the housing 20;
S60: after the parts of the two terminals 1 other than their roots are inserted into the housing 20, stopping the mobile seat 202, opening the terminal clamping device 110,11, and clamping the roots of the two core wires 10a with the core wire clamping device 120,12;
S70: further inserting the two terminals 1 by moving the mobile seat 202 until the roots of the two terminals 1 are inserted into the housing 20;
S80: after the roots of the two terminals 1 are inserted into the housing 20, stopping the mobile seat 202 and opening the core wire clamping device 120,12; and
S90: further inserting the two terminals 1 by moving the mobile seat 202 until the roots of the two core wires 10a are inserted into the housing 20.

In addition, those areas in which it is believed that those of ordinary skill in the art are familiar, have not been described herein in order not to unnecessarily obscure the invention described. Accordingly, it has to be understood that the invention is not to be limited by the specific illustrative embodiments, but only by the scope of the appended claims.

It should be appreciated for those skilled in this art that the above embodiments are intended to be illustrated, and not restrictive. For example, many modifications may be made to the above embodiments by those skilled in this art, and various features described in different embodiments may be freely combined with each other without conflicting in configuration or principle.

Although several exemplary embodiments have been shown and described, it would be appreciated by those skilled in the art that various changes or modifications may be made in these embodiments without departing from the principles and spirit of the disclosure, the scope of which is defined in the claims and their equivalents.

As used herein, an element recited in the singular and proceeded with the word “a” or “an” should be understood as not excluding plural of the elements or steps, unless such exclusion is explicitly stated. Furthermore, references to “one embodiment” of the present disclosure are not intended to be interpreted as excluding the existence of additional embodiments that also incorporate the recited features. Moreover, unless explicitly stated to the contrary, embodiments “comprising” or “having” an element or a plurality of elements having a particular property may include additional such elements not having that property.

What is claimed is:

1. An insertion device for inserting a cable assembly into a housing, the cable assembly including a cable and two terminals crimped on two exposed core wires of the cable, comprising:
a cable control module including:
a terminal clamping device adapted to clamp to the two terminals; and
a core wire clamping device adapted to clamp to the two core wires; and
a housing control module including a housing clamping device adapted to hold the housing while the two terminals are inserted into the housing.

2. The insertion device according to claim 1, wherein the housing control module includes a mobile seat movable along a longitudinal direction of the terminal relative to the terminal, the housing clamping device is installed on the mobile seat such that two terminals are insertable into the housing by driving the mobile seat.

3. The insertion device according to claim 2, wherein the housing clamping device comprises:
a housing clamp installed on the mobile seat and adapted to be opened and closed; and
a housing clamp driver installed on the mobile seat and driving the housing clamp to open and close.

4. The insertion device according to claim 3, wherein the housing clamp comprises:
a base fixed on the mobile seat and having a positioning groove for positioning the housing;
a clamping arm rotatably connected to the base and adapted to be opened and closed relative to the base; and
a connecting arm rotatably connected to the clamping arm, the housing clamp driver comprises a cylinder including a cylinder block rotatably connected to the mobile seat and a telescopic rod connected to the connecting arm.

5. The insertion device according to claim 2, wherein the housing control module further includes a guide device installed on the mobile seat to guide front ends of two terminals into the housing.

6. The insertion device according to claim 5, wherein the guide device comprises:
a guide member including a pair of guide member halves adapted to be opened and closed; and
a guide member driver driving the pair of guide member halves to open and close, a semi-conical guide hole is formed on the guide member half, and when the pair of guide member halves are closed, a conical guide hole for guiding the terminal into the housing is formed.

7. The insertion device according to claim 6, wherein two semi-conical guide holes arranged side by side are formed on the guide member half, when the pair of guide member halves are closed, two conical guide holes arranged side by side are formed to guide the two terminals into two terminal slots of the housing.

8. The insertion device according to claim 6, wherein:
in the process of inserting the front ends of the two terminals into the housing, the pair of guide member halves are closed to form a conical guide hole that guides the two terminals into the housing; and
after the front ends of the two terminals have been inserted into the housing, the pair of guide member halves are opened to allow the parts other than the front ends of the two terminals to be inserted into the housing.

9. The insertion device according to claim 2, wherein the housing control module further comprises:
a fixed seat on which the mobile seat is movably installed; and
a mobile seat driver installed on the fixed seat and driving the mobile seat to move along the longitudinal direction of the terminal.

10. The insertion device according to claim 9, wherein the mobile seat driver comprises:
a servo motor installed on the fixed seat; and
a transmission mechanism connected between an output shaft of the servo motor and the mobile seat, the transmission mechanism is adapted to convert a rotation of the output shaft of the servo motor into the linear movement of the mobile seat.

11. The insertion device according to claim 10, wherein the transmission mechanism comprises:
a lead screw drive mechanism having a lead screw and a nut threaded with the lead screw; and
a pulley drive mechanism connected between the output shaft of the servo motor and the lead screw of the lead screw drive mechanism, the nut of the lead screw drive mechanism is connected to the mobile seat.

12. The insertion device according to claim 1, wherein the terminal clamping device comprises:
a terminal clamp including two terminal clamp halves adapted to be opened and closed; and
a terminal clamp driver driving the two terminal clamp halves to open and close to clamp or loosen the two terminals.

13. The insertion device according to claim 12, wherein:
two terminal positioning grooves adapted to position roots of two terminals are formed on one of the two terminal clamp halves; and
two terminal positioning protrusions adapted to retain the roots of two terminals in the two terminal positioning grooves are formed on the other of the two terminal clamp halves.

14. The insertion device according to claim 12, wherein:
the two terminals are arranged side by side in a first direction, the first direction vertical to the longitudinal direction of the terminal; and
the two terminal clamp halves are opened and closed in a second direction perpendicular to the first direction and the longitudinal direction of the terminal.

15. The insertion device according to claim 1, wherein the core wire clamping device comprises:
a core wire clamp including a pair of core wire clamp halves adapted to be opened and closed; and
a core wire clamp driver driving the pair of core wire clamp halves to open and close.

16. The insertion device according to claim 15, wherein:
the two terminals are arranged side by side in a first direction, the first direction vertical to the longitudinal direction of the terminal; and
the pair of core wire clamp halves are opened and closed in the first direction.

17. The insertion device according to claim 16, wherein:
the two exposed core wires of the cable are arranged side by side in the first direction; and
in the process of inserting roots of the two terminals into the housing, the pair of core wire clamp halves clamp the two core wires in the first direction.

18. The insertion device according to claim 1, wherein the cable control module further comprises:
a first cable support frame on which a cable positioning slot for positioning and supporting the cable is formed; and
a second frame on which the terminal clamping device, the core wire clamping device and the cable support frame are installed.

19. The insertion device according to claim 1, wherein after roots of the two terminals are inserted into the housing, the core wire clamping device is adapted to open to permit further insertion of the two terminals until the roots of the two core wires are inserted into the housing.

20. A method for inserting a cable assembly into a housing with an insertion device comprising the steps of:
clamping the housing with a housing clamping device of a housing control module of the insertion device;
clamping roots of two terminals of the cable assembly with a terminal clamping device of a cable control module of the insertion device;
inserting front ends of the two terminals into the housing by moving a mobile seat of the housing control module, the front ends of the two terminals inserted into the housing under the guidance of a guide device of the housing control module;
after the front ends of the two terminals are inserted into the housing, stopping the mobile seat and opening the guide device;
further inserting the two terminals by moving the mobile seat until parts of the two terminals other than their roots are inserted into the housing;
after the parts of the two terminals other than their roots are inserted into the housing, stopping the mobile seat, opening the terminal clamping device and clamping roots of the two core wires with a core wire clamping device of the cable control module;
further inserting the two terminals by moving the mobile seat until the roots of the two terminals are inserted into the housing;
after the roots of the two terminals are inserted into the housing, stopping the mobile seat and opening the core wire clamping device; and
further inserting the two terminals by moving the mobile seat until the roots of the two core wires are inserted into the housing.
